(19) United States
(12) Patent Application Publication
(10) Pub. No.: US 2006/0224673 A1
(43) Pub. Date: Oct. 5, 2006

(54) Throttling inbound electronic messages in a message processing system

(75) Inventors: Pablo M. Stern, San Francisco, CA (US); Eliot C. Gillum, Los Gatos, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/094,647

(22) Filed: Mar. 30, 2005

(51) Int. Cl. G06F 15/16

(52) U.S. Cl. 709/206

(57) ABSTRACT

Providing for proactive and/or active processing of message events is provided. Message event information received by the system is aggregated, a message event throttling policy is generated from the aggregated information and distributed globally. Subsequent message events are then processed using the global rules and/or policies as well as local policies. Message events from unrecognized senders are applied a default processing. Message events from known senders are applied a processing level based on historical message event trends.

### CROSS REFERENCE TO RELATED INVENTION

The instant non-provisional application is related to the following patent application, which is hereby incorporated by reference in their entirety:

U.S. patent application Ser. No. 11/023,293, filed on Dec. 27, 2004, entitled “Identification of Email Forwarders”, having inventors Geoffrey Hulten et al., currently pending.

### BACKGROUND OF THE INVENTION

1. Field of the Invention

The present invention is directed to processing undesirable electronic mail messages by a message processing system.

2. Description of the Related Art

Email is one of the most popular means of communication over the Internet. Along with its popularity, Unsolicited Bulk Email (UBE) has become widespread as well. UBE may include unsolicited commercial email, spam and other unsolicited bulk emails. UBE typically consists of unwanted electronic advertisement or solicitation messages sent to large numbers of recipient email addresses. Many email accounts are flooded with unwanted UBE, detracting from the user experience provided by email service providers and causing some email accounts to reach near unusable states.

Originators of UBE (spammers) harness the processing power of numerous mail server machines to send UBE. Generally, spammers hide the origin of UBE by utilizing unsuspecting servers on the Internet, known as zombies, or culling through dynamic internet protocol (IP) space. Using these methods, spammers can flood large mail processing systems to the brink of their inbound email capacity. Flooding mail processing systems in this manner results in less bandwidth made available to process legitimate email.

Large scale email service providers (ESPs) can stop a limited amount of mass UBE mailings using anti-spam software. Most anti-spam software applications detect and delete spam. Various spam detection mechanisms exists, including comparing the sending IP address to a list of known spammer addresses or confirming the validity of the sending IP address with a Domain Name Service (DNS) server. Though typical anti-spam applications remove a portion of incoming UBE from user accounts, they do not prevent all UBE from being delivered to user email accounts.

Large-scale Email Service Providers (ESPs) are disadvantaged in processing UBE by the sheer magnitude of their mailing infrastructure and inbound email accepting capacity. The mailing infrastructure of a large-scale ESP typically includes a number of mail transfer agents (MTAs). Anti-spam software can be executed at each MTA to detect and delete some UBE. As the number of UBE received by a system increases, the processing power required to filter out the UBE increases as well. Though additional MTAs can be used to add additional processing power, an ESP mailing infrastructure can only handle a certain number MTAs before the system becomes unmanageable. At such a scale, the sheer number of MTAs creates a bottleneck to administer a truly centralized real-time mechanism to block spammers.

### SUMMARY OF THE INVENTION

The technology herein, roughly described, includes a system and method for proactively and or reactively throttling incoming electronic message events.

In one embodiment, a method for processing incoming message events is disclosed which begins with determining a unique sender of a received incoming event. Next, a default level of event processing associated with the unique sender is set. Incoming events from the unique sender are selectively processed based on the default level of event processing.

In another embodiment, a method for processing incoming message events begins with receiving a message event from a recognized unique sender. Next, a processing rule is retrieved which is associated with the recognized unique sender. Processing of subsequent message events received from the unique sender is limited based on the retrieved processing rule.

In yet another embodiment, a system for processing electronic events includes a plurality of message transfer agents and an aggregation server. Each of the plurality of message transfer agents may generate message event information from message events received from one or more unique senders, and accept a limited number of message events associated with a processing level for each unique sender. The aggregation server receives message event information from each of the transfer agents and provides the unique sender processing levels to the plurality of message servers.

### BRIEF DESCRIPTION OF THE DRAWINGS

FIG. 1 illustrates one embodiment of a system for exchanging electronic messages over a network.

FIG. 2 illustrates one embodiment of a mail server.

FIG. 3 illustrates one embodiment of a computing device.

FIG. 4 illustrates one embodiment of a method for processing electronic messages.

FIG. 5 illustrates one embodiment of a method for processing incoming electronic messages by an MTA.

FIG. 6 illustrates one embodiment of a method for processing incoming electronic messages using message processing rules.

FIG. 7 illustrates one embodiment of a method for determining whether a message requires performance of a processing action.

FIG. 8 illustrates one embodiment of a method for processing message information by a message information store.

FIG. 9 illustrates one embodiment of a method for updating message processing rules.

FIG. 10 illustrates one embodiment of a source IP address aggregation table.

FIG. 11 illustrates one embodiment of a source IP address rule table.

FIG. 12 illustrates one embodiment of a method for processing electronic messages by a router.

### DETAILED DESCRIPTION

A system and method which provide for proactive and/or active processing of message events is provided. Such message events can include electronic messages, email, connection requests, and other incoming message events. System processing of such events can include throttling and/or otherwise processing subsequent message events. Throttling subsequent incoming message events reduces the quantity of message events from a unique sender that are processed by a system. A unique sender is a message event source identifier that is unique throughout the system. A unique sender may be identified as an IP source address, a domain, or some other information identifying a sender of a message event in a unique way. In one embodiment, the electronic message events are email connection requests, but may also include electronic messages, and other events

Email may be processed by an email system at mail transfer agents (MTAs). Connection requests may be processed by either the MTAs or by a router. The electronic message events are processed using default rules and/or policies, or rules or policies derived from the received electronic message information. A message information store receives the electronic message information, aggregates the information, develops rules from the information and transmits the rules to servers processing subsequent electronic messages and one or more routers. The rules limit the influx, or otherwise affect the processing, of electronic messages received from a unique sender associated with previously received undesirable electronic messages.

Limiting the recipients per data received is useful because it increases the cost of sending messages for a sender, thereby penalizing senders of large quantities of emails. In some cases, when a unique sender is identified as sending an undesirable number of UBE messages (whether UBE message events from the sender surpass an allowable threshold percentage, a threshold quantity, or, in some cases, sending any UBE at all), message events from the unique sender may be completely blocked off from the message event processing system. This is done to prevent UBE senders from getting more UBE through the system that allows a small fraction of UBE to be go through to end users or be processed in other ways. For purposes of illustration, electronic messages and/or emails are described below as being processed based on the source IP associated with the message. It is intended that the source IP information used to process electronic messages and/or email is interchangeable with any other type of unique sender information.

Reactive throttling, or reactive processing, is used to process connection requests and electronic messages from unique senders that have been known to exhibit undesirable behavior. For example, reactive blocking may involve refusing to process connection requests and electronic messages from a unique sender based on matches found in a block list. The block list may or may not be generated by the system using it. Reactive processing is discussed in more detail below with respect to processing connection requests and electronic messages.

Proactive throttling, or proactive processing, is used to process connection requests and electronic messages from a new unique sender that is not recognized or for which little is known of their behavior. For example, a default processing level may be assigned to incoming events for a new or unrecognized unique sender. The default processing level may either be improved or degraded depending on the subsequent detected behavior of the unique sender. A slightly higher, or lower, default processing level may be associated with a new unique sender that is similar to another unique sender which has a good, or bad, past behavior pattern. Proactive processing is discussed in more detail below with respect to processing connection requests and electronic messages.

In one embodiment, a large scale email system can have hundreds of MTAs used to process and forward incoming electronic messages to an electronic message store. A router within the mail system may receive incoming connection requests (intent on delivering electronic messages) and route them to the MTAs. A message information store (MIS) receives message information from each MTA. The MIS aggregates the message information (for example, into a table) and generates rules for processing subsequent electronic messages and connection requests received by the mail system. The rules are derived from the aggregated message information and can be applied to electronic messages received from different electronic message sources (for example, different source IP addresses). Once generated, the rules are sent to the router and the MTAs for application on incoming connections and messages.

For example, the message information received by the MIS from the MTAs may indicate that messages received from a particular electronic unique sender are ninety percent unsolicited bulk email (UBE). In this case, the MIS can generate a rule that requires the router to block future connection requests and/or MTAs to block messages received from the electronic message source. The rule can be applied at a router, an MTA or an email storage server. Systems and methods illustrating embodiments of the invention are discussed in more detail below.

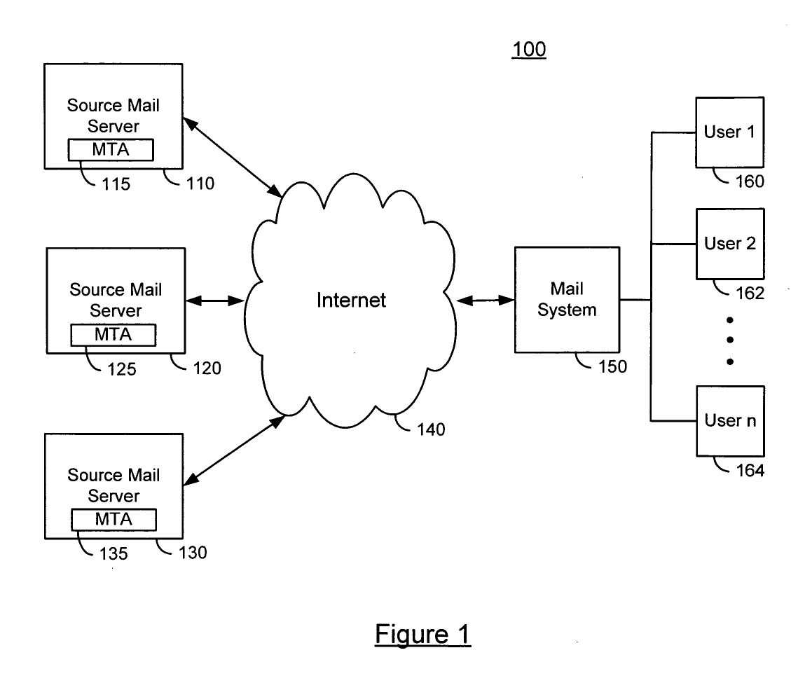

An electronic message processing system 150 for processing message events (such as incoming electronic messages, email, or connection requests) over a network (such as the Internet) is illustrated in FIG. 1. FIG. 1 includes source mail servers 110, 120 and 130, Internet 140, electronic message processing system 150 and users 160, 162 and 164. Source mail servers each include a mail transfer agent (MTA) 115, 125 and 135, respectively. MTAs 115-135 communicate with electronic message processing system 150 through Internet 140. Users can access electronic message processing system 150 to view as well as send and receive electronic messages over Internet 140.

Electronic messages are typically sent over the Internet using the simple mail transfer protocol (SMTP) standard. SMTP involves a protocol for sending electronic messages from a sending mail server to a receiving mail server. A mail server or MTA typically includes an SMTP server. The sending mail server's SMTP (sending SMTP server) may receive sender address information, recipient address information and the message body from an email client. The address information will include a recipient and a domain name. For example, for jonsmith@mail.com, the recipient is jonsmith and the domain name is mail.com. The sending SMTP server then contacts a Domain Name Server (DNS) to retrieve the IP address of the SMTP server associated with the recipient address domain name. The sending SMTP server then establishes a connection with the SMTP server at the receiving mail server (receiving SMTP server). After establishing a connection, the sending SMTP server provides the message information to the receiving SMTP server. An example of the communication steps required to send an electronic message between a sending SMTP server and a receiving SMTP server is illustrated below. The same communication steps can be used to send an electronic message between the email client and the sending SMTP server. For the example below, the message is sent by adam@mailsender.com to bob@mailreceiver.com.

helo test Sending SMTP

250 mx1.mailreceiver.com Hello abc.mailsender.com [220.57.69.37], pleased to meet you

mail from: adam@mailsender.com Sending SMTP

250 2.1.0 adam@mailsender.com . . . Sender ok

rcpt to: bob@mailreceiver.com Sending SMTP

250 2.1.5 bob . . . recipient ok

data Sending SMTP

354 Enter mail, end with “.” on a line by itself

from: adam@mailsender.com Sending SMTP

to: bob@mailreceiver.com Sending SMTP

subject: testing Sending SMTP

Sending SMTP

Test message content Sending SMTP

. Sending SMTP

250 2.0.0 e1 NMajH24604 Message Accepted for delivery

quit Sending SMTP

221 2.0.0 mx1.mailreceiver.com closing connection

The messages sent by the sending SMTP server to the receiving SMTP server are indicated above. Steps not sent by the sending SMTP are sent by the receiving SMTP server to the sending SMTP server. In short, the sending SMTP server initiates contact with the receiving SMTP server with the “HELO” command. The receiving SMTP server then sends a confirmation message to the sending SMTP server indicating the connection has been established. The sending SMTP server then provides information regarding the sender of the message (adam@mailsender.com). The receiving SMTP server then confirms that the sender of the message is an ok sender. Information is then sent and confirmed for the recipient of the message, followed by the transmission of the data comprising the message. After the receiving SMTP server confirms the message is accepted for delivery, the sending SMTP server quits. The receiving SMTP server then closes the connection.

As illustrated above, an electronic message sent via SMTP includes source information, recipient information and data information. The source information typically includes a source Internet Protocol (IP) address. The source Internet Protocol address is a unique address from which the electronic message originated and may represent a single server, a group of servers or a virtual server.

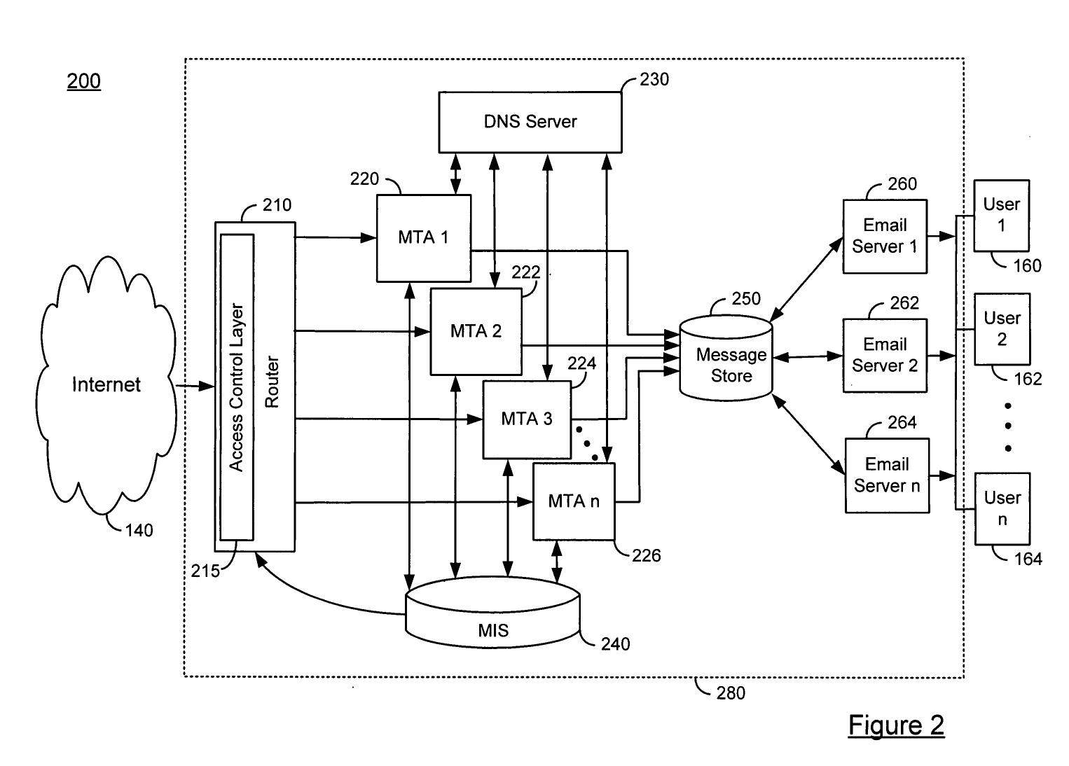

Electronic message processing system 280 of FIG. 2 illustrates one embodiment of receiving mail system 150 of FIG. 1 in more detail. System 280 includes router 210, MTAs 220, 222, 224 and 226, domain name service (DNS) server 230, message information store (MIS) 240, message store 250 and email servers 260, 262 and 264. Router 210, MTAs 220-226, DNS 230 and MIS 240 may communicate in a variety of protocols, including but not limited to tcp, udp, broadcast, multicast, SMTP, HTTP, FTP, file sharing, a database procedure or some other protocol. System 280 may communicate with Internet 140 and users 160-164.

Router 210 receives incoming connection requests from Internet 140. In one embodiment, router 210 may either accept or reject the incoming connection request attempt. In another embodiment, router 210 accepts the incoming connection request attempt and then either sends or drops an outgoing response. In this case, the sending client isn't able to establish a connection with system 280 because they never receive a response to their connection attempt. In a further embodiment, router 210 redirects the connection request response to a special purpose server, which sends a connection reset message to MTAs 220-226 to prevent them from consuming further resources on the connection attempt. By accepting the connection request, router 210 allows messages to be received by an MTA. Router 210 also includes access control layer 215. Access control layer 215 determines which connections to drop or route to MTAs 220-226. This is discussed in more detail below.

MTAs 220-226 receive routed connection requests and electronic messages from router 210, process the connection requests and messages, and forward the messages to message store 250. Though only four MTAs are illustrated in FIG. 200, a system for receiving electronic messages may include any number of MTAs. In one embodiment, a large scale electronic message processing system may include hundreds of MTAs. MTAs 220-226 can send and receive information with MIS 240, DNS server 230, and message store 250. In one embodiment, electronic message processing information is exchanged between the MTAs and message information store 240. MTAs 220-226 can exchange domain name information and source IP address requests with DNS server 230. The MTAs can provide electronic messages to message store 250. Message store 250 provides messages to email servers 260, 262 and 264 on request.

Message information store 240 is used to aggregate message information and develop connection request and electronic message processing policies. The electronic message and connection request processing policies are distributed as a set of rules or heuristics to MTAs 220-226 and router 210. The rules allow MTAs 220-226 to throttle incoming electronic message traffic by inhibiting or reducing the influx of electronic messages and router 210 to throttle incoming connection requests that are determined to come from a bad, suspicious, unknown, or other type of source not determined to be trusted. This is discussed in more detail below.

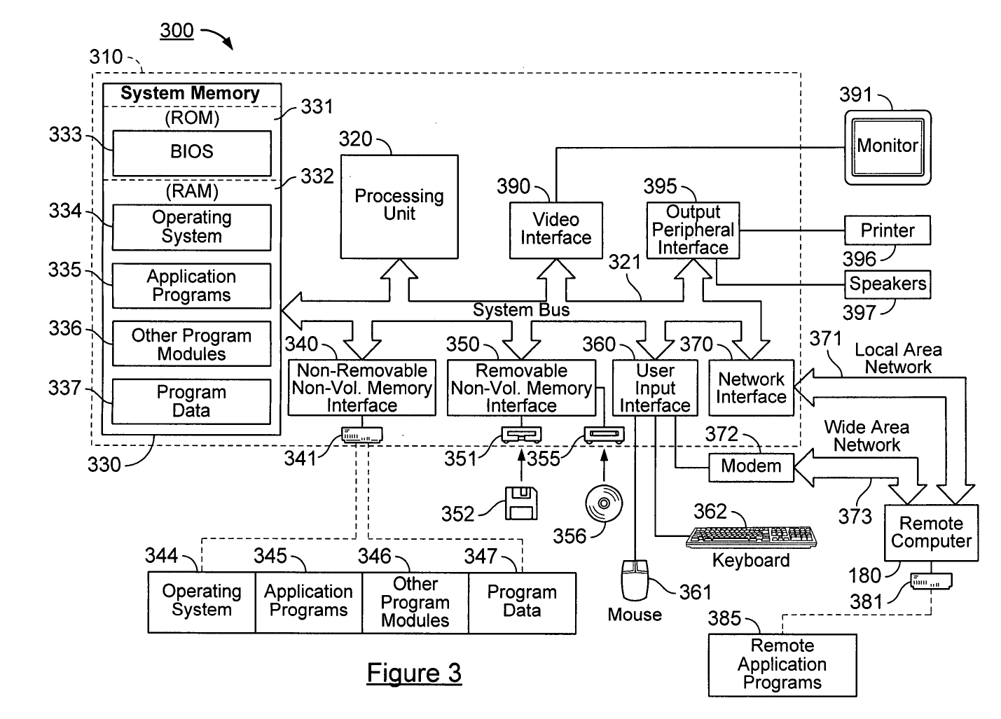

System 300 of FIG. 3 illustrates an example of a computing device that can be used to implement elements 210-264 of system 280. FIG. 3 illustrates an example of a suitable computing system environment 300 on which the invention may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the invention includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through a output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

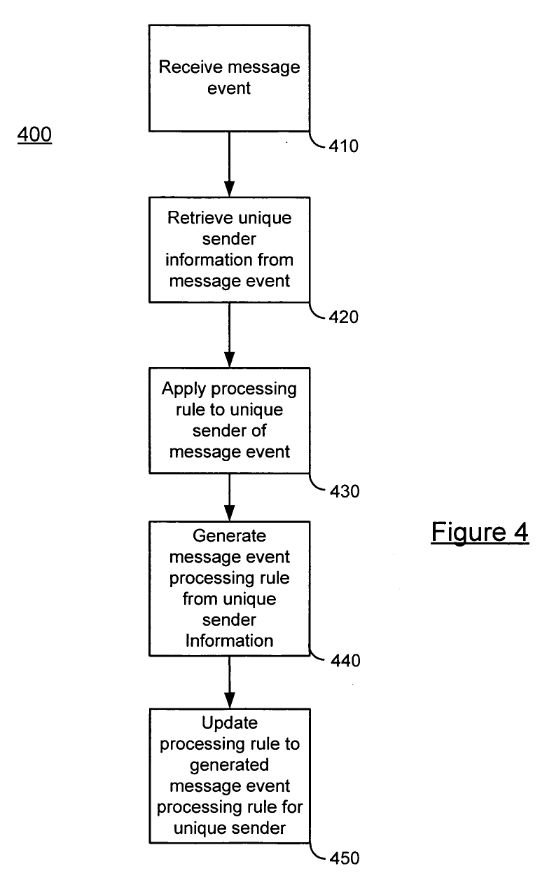

Method 400 of FIG. 4 illustrates a method for proactively and reactively processing message events received by electronic message processing system 150 of FIG. 2. The steps of method 400 are performed by different modules within system 150 and discussed in more detail below.

Messages events are received at step 410. Unique sender information is retrieved from the message events at step 420. In one embodiment, the unique sender information retrieved includes a source IP address.

Message processing rules are then applied at step 430. In the case wherein the unique sender is not recognized, one or more default processing rules are then applied to the message event from the new unique sender at step 430. In one embodiment, default processing is proactively applied to all message events from unique senders that are not recognized or for which no or little information is known regarding their previous incoming event behavior. This limits the influx of incoming events and the resulting impact on system resources that an unrecognized unique sender can cause. Alternatively, one or more processing rules generated for a known unique sender is applied. Such rules are developed from events and messages previously received from the known unique sender. Message processing rules may specify processing actions to apply to messages or message events received from a unique sender, including message or message event filtering, other processing of messages or message events, or blocking, throttling or other limitations placed on the influx of incoming messages or message events. Message processing rules and processing actions are discussed in more detail below.

The default level of event processing is associated with each unique sender. Once the default level of event processing is set, incoming events from the unique sender are selectively processed based on the default level of event processing. The selective processing of incoming events is discussed in more detail below.

Message event processing rules are then generated from the unique sender information at step 440. In one embodiment, the processing rules can include rules and/or heuristics for processing and/or throttling subsequent received message events. The rules can be determined from past electronic messages, or connection requests, or other events received from one or more unique senders. For example, if the fraction of messages that are UBE messages from a unique sender exceeds a threshold, a rule may be generated that requires all messages from that unique sender to be blocked. Next, the default processing rule is updated to the message event processing rule generated at step 440 for the unique sender at step 450. In one embodiment, the processing or throttling of one or more message events from a unique sender reduces and/or inhibits the influx of electronic events received from the unique sender. The adjusted level of event processing is based on whether or not the incoming events are approved or unwanted. In a further embodiment, message processing events may trigger “offline” events, such as using DNS to obtain a hostname for the IP. Embodiments illustrating details for the steps of method 400 are discussed in more detail below.

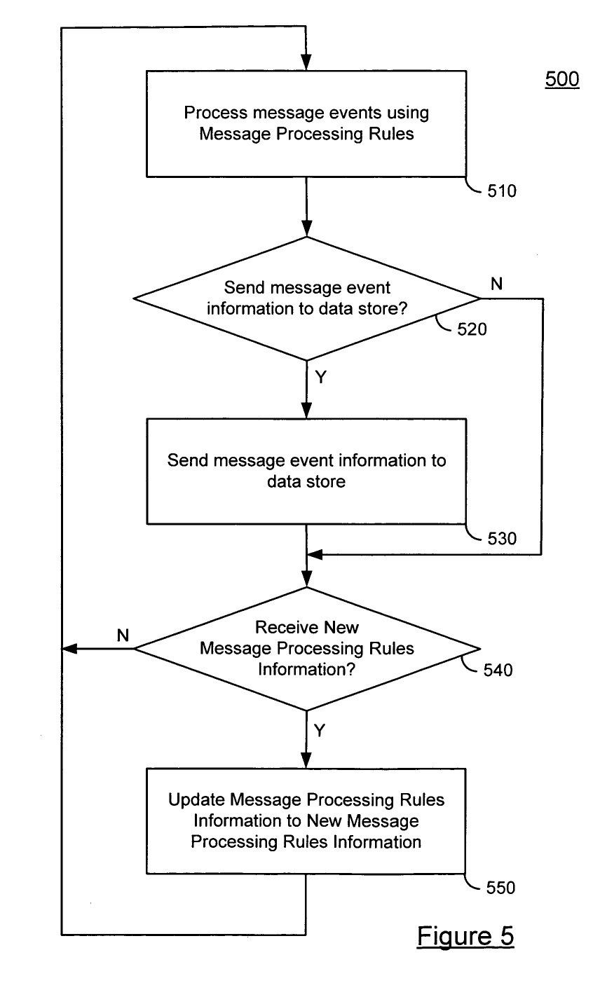

FIG. 5 illustrates one embodiment of a method 500 for processing message events by a server such as one of MTAs 220-226 of FIG. 2. First, message events, such as electronic messages and/or connection requests, are processed using message processing rules at step 510. This step is generally equivalent to step 430 in method 400. The message processing rules can include UBE processing rules and other rules. The processing step can include blocking, receiving, storing and processing or otherwise applying rules to one or more connection requests or electronic messages. Step 510 is discussed in more detail below.

Next, a determination is made as to whether to send message event information to a data store at step 520. The data store may be MIS 240 or a local memory on the particular MTA. If message event information is determined to be sent at step 520, operation continues to step 530. If message event information is not to be sent at step 520, operation continues to step 540.

In some embodiments, each MTA may transmit electronic message information received at step 510 to a data store upon detection of the transmission event. The transmission event may be receipt of a transmission signal from the data store or some other source, accumulation of message event information, expiration of a timer, a counter event, or some other event. For example, an electronic message information transmission event may be configured to occur every hour. In this case, each MTA will send electronic message information to MIS 240 or its local data store once an hour. In another embodiment, message event information is sent both at the time of the event occurrence and at a later time, although not all data may be transmitted in the former case.

In one embodiment, the message event transmission to MIS 240 may be synchronized for each MTA so that each MTA sends electronic message information at about the same time or within a time window (such as five minutes). In another embodiment, each MTA sends electronic message information to the MIS within a time window, delaying the transmission of the information by an amount calculated to achieve a coordinated reduction in the resources required to receive the data from all the MTAs.

Message event information is sent to a data store at step 530. In one embodiment, the message event information is sent to MIS 240 through a tier structure. A tier structure can be used to reduce the load on MIS 240 when a large number of MTAs are used. In a tier structure, a number of MTAs send message event information to a representative MTA. For example, in a system having 400 MTAs, groups of 40 MTAs may send information to a representative MTA. The 10 representative MTAs will then send the collected message event information to MIS 240. In another embodiment, groups of MTAs can send information to an intermediary aggregating server (not illustrated in FIG. 2). The intermediary aggregating servers would then send the collected information to MIS 240. In either case, only a fraction of the number of servers (the 400 MTAs) are attempting to send information to MIS 240 after the transmission event. After message event information has been sent, operation continues to step 540.

The MTA then determines whether new message processing rules information has been received at step 540. In one embodiment, the new message processing rules information is received from MIS 240. The new message processing rules can be received directly or through a reverse tier system similar to that described above. In another embodiment, the new message processing rules information is received from the local data store of the MTA. If no new message processing rules information is received at step 540, operation continues to step 510. If new message processing rules information is received at step 540, operation continues to step 550. Details and generation of message processing rules are discussed in more detail below.

The MTA updates the existing message processing rules information to the new message processing rules information at step 550. The existing message processing rules may be default processing rules and/or previously generated message processing rules. In one embodiment, the update is performed by replacing the rules in MTA memory. The MTA will then use the updated message processing rules to process subsequent message events, such as connection requests and received electronic messages, from various unique senders. This process is discussed in more detail below.

In one embodiment, steps 510-540 of method 500 are performed in real time by an MTA. In some embodiments, when a plurality of MTAs performs the process in real time, a message processing policy can be applied globally to a network of MTAs (such as MTAs 220-226 of FIG. 2). In another embodiment, an MTA may perform the process in real time but store the information locally apply the resulting message processing policy locally. To achieve real time performance, a message event or incoming event log is sampled at each MTA. An incoming event log includes information for each incoming event for the MTA, such as connection requests, sender information for connection requests, message information and other information.

At each transmission event, there is a probability that incoming electronic messages or connection requests from senders (all of which are logged in the incoming event log) will be sampled. The sampled results are then transmitted by the MTA in response to the transmission event. The sample rate may depend on system design. A high sample rate requires more processing power and captures a larger, more accurate sampling of data to extrapolate from. A lower sampling rate requires less processing power but captures a smaller sampling of data to extrapolate from. The smaller sampling of data makes for a less accurate extrapolation. Thus, for a smaller sampling rate, it takes more time to capture a number of events required to perform an accurate extrapolation. In one embodiment, a sampling of one percent (1%) of an incoming event log can be used to obtain an accurate sampling for extrapolation. In some embodiments, a sampling rate is selected such that one thousand unwanted message events associated with a unique sender can be detected with reasonable reliability in a reasonably short period of time.

Once the events are sampled, the sampling data is transferred to a central source, such as MIS 240. This electronic message information transmission event may be triggered to occur at short intervals, for example, every second. In one embodiment, the sampled data is transferred through a connectionless datagram service. For example, each MTA may transfer the sampled data to the MIS 240 via UDP packets. This works well with a large number of MTAs and a busy system because the transport mechanism is lightweight and does not require a connection between the sending and receiving entity. Although UDP does not guarantee packet delivery, for such a sampling some packet loss is non critical to the proper operation of the system

After the data is processed by the receiving entity, such as MIS 240, updated processing rules are sent back to the MTAs (as in step 540). In one embodiment, the updated processing rules are sent in some manner that is verifiable by the sending entity. For example, the updated processing rules may be sent through a broadcast, multi-cast, frequent polling, TCP connection, UDP packets with an acknowledgment, or some other means.

For senders that send a larger number of messages to an MTA, for example, over 10,000 an hour, there is a high likelihood that the sampled results will include a representative portion of the messages sent from that sender. An approximate number of actual electronic messages received from a sender over a period of time may be extrapolated from the sampled results. For example, if the sampling rate is one every one thousand log events, and eight messages from a particular sender are sampled over a minute, extrapolation results in an approximation of 8,000 messages received from the particular sender over the one minute period. In one embodiment, a sampling rate can be chosen such that a sufficiently accurate extrapolation can be made of a unique sender's message sending behavior, while keeping the rate low enough to be processed in real time.

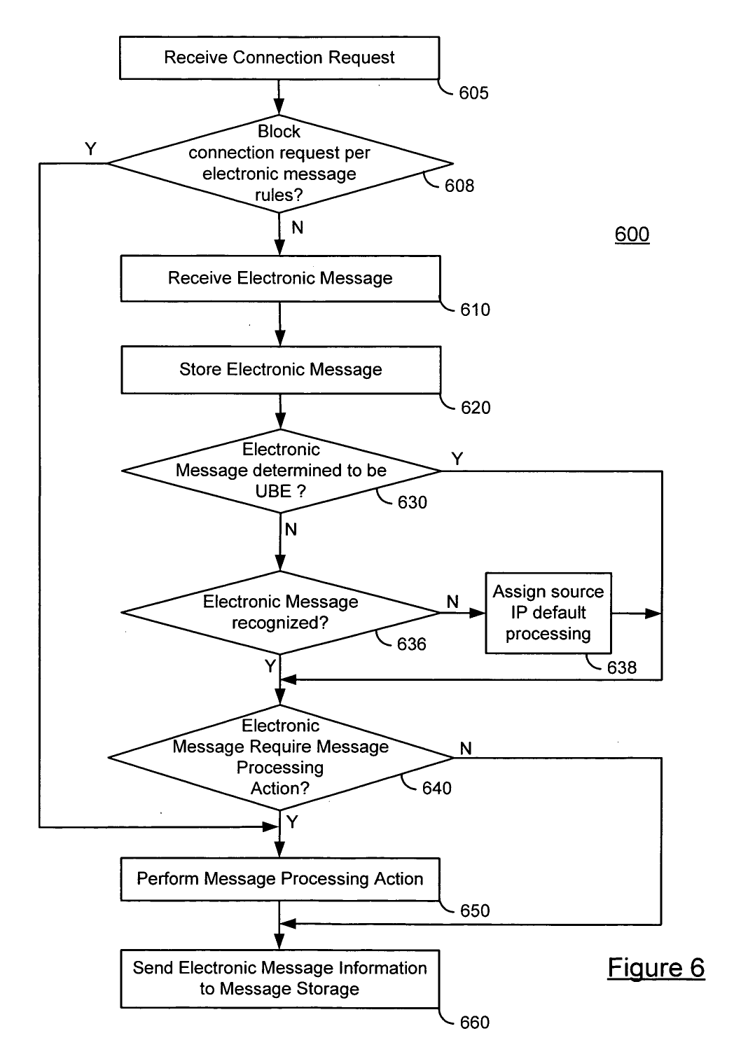

FIG. 6 illustrates one embodiment of a method 600 for processing a message event by an MTA using message processing rules as discussed above in step 430 of method 400. Method 600 may also be used to implement step 510 of method 500. In the embodiment illustrated in method 600, the message event is a connection request, followed by an associated electronic message. In other embodiments, an MTA may process either the connection request or electronic message without the other. A connection request is received at step 605. In one embodiment, the connection request is received from router 210. Next, the MTA determines whether to block the connection request at step 608. In making this determination, an MTA may access message processing rules.

In one embodiment, the determination as to whether a connection request should be blocked is similar to the steps performed in method 700 (discussed in more detail below) for determining whether to process a received electronic message. If the connection request should be blocked, operation continues to step 650 wherein the message event processing action consists of blocking the connection request. Blocking message events is discussed in more detail below. In one embodiment, processing the connection request before the email is received requires less processing time than that required to accept the connection, receive the message and persist the message on the MTA. This may be advantageous for a system or MTA processing large numbers of electronic messages. If the connection request should not be blocked, operation continues to step 610.

Next, an electronic message associated with the connection request is received at step 610. In one embodiment, the electronic message is received by an MTA from router 210. The received electronic message is then stored at step 620. In one embodiment, electronic message information is stored in local memory on the MTA. In some embodiments, a record of the electronic message is stored as an entry in a message or incoming event log. An MTA then determines if the received electronic message is UBE at step 630. In one embodiment, UBE, is detected by widely available commercial software programs running locally on the MTA. If the electronic message is determined to be UBE at step 630, operation continues to step 640. If the electronic message is determined not to be UBE, operation continues to step 636.

In one embodiment, to determine whether an electronic message is UBE, an MTA (or a software application running on an MTA) will send unique sender information retrieved from the electronic message to DNS Server 230. In one embodiment, the unique sender information includes source IP address information. Upon receiving the request, the DNS server will look up the received unique sender information and generate a response. When the request includes a source IP address, the response can typically include the domain name associated with the electronic message's unique sender. In other embodiments, if only the domain name of the unique sender is known, an MTA may send the DNS server the domain name associated with the unique sender of an electronic message. In this case, the DNS server will respond with the source IP address associated with the domain name. If either the source IP address or domain name is not associated with a valid electronic message source, DNS server will indicate this to the requesting entity. When an MTA receives a response from a DNS server indicating the IP address or domain name is invalid, the MTA may classify the unique sender as a bad source.

At step 636, a determination is made as to whether the unique sender associated with of the received electronic message is recognized. If the unique sender is not recognized, operation continues to step 638. If the unique sender is recognized, operation continues to step 640.

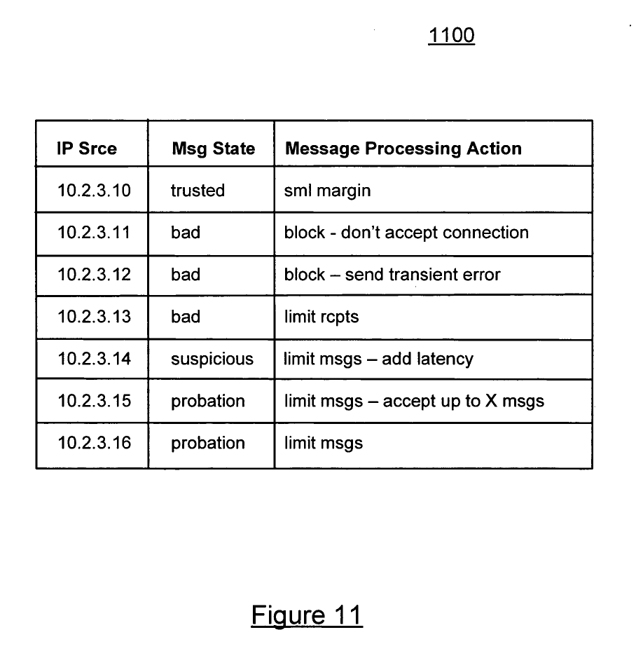

In one embodiment, the MTA checks the received source IP address of the received electronic message against a table of known electronic message IP addresses. An example of a source IP address rule table is discussed below with reference to FIG. 11. If the source IP address associated with an electronic message is not found on the source IP processing list, then operation continues to step 638. In this case, the unique sender of the electronic message is a new unique sender of which no information is known. As a result, it is not known whether the unique sender should be trusted or not. If the source IP information from the received electronic message is located on the source IP processing list, operation continues to step 640.

A default message processing level is assigned to the unique sender at step 638. Operation then continues to step 640. In one embodiment, the default message processing level allows a limited number of message events to be accepted from the unrecognized unique sender. The limited number of message events does not allow unlimited influx of message events from the unique sender. Rather, the default processing level allows the unique sender to send a reasonable but controlled number of events (connection requests, electronic messages, etc.) to the system of the present invention. As future incoming events are received for the unrecognized unique sender and the unique sender's behavior can be categorized as either good or bad, the level of accepted incoming events for the unique sender will change accordingly.

In one embodiment, the unique sender IP may be unrecognized but similar to a recognized unique sender IP. For example, an unrecognized unique sender of mailserver2.eauction.com is similar to a recognized sender of mailserver1.eauction.com (same domain of eauction.com). In this case, a default processing level for the unrecognized unique sender IP may be set similar to the recognized unique sender IP processing level. If no information is available regarding the unrecognized unique sender IP, then a default role having a default processing level will be assigned. The default processing level will be less than a processing level assigned to unique sender IPs with favorable behavior, but better than unique sender IPs with unfavorable behavior. After setting a default behavior, operation continues to step 640.

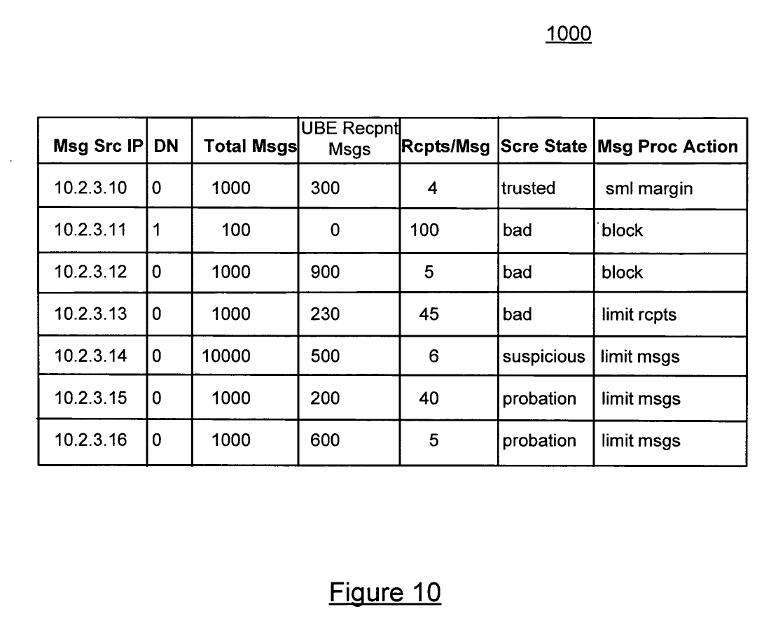

At step 640, the MTA determines whether the electronic message requires performance of a message processing action. In one embodiment, if the electronic message is from a unique sender having a trusted IP state or otherwise considered “good”, the electronic message processing level may be minimal. In any case, the processing of subsequent message events received from the recognized unique sender may be limited based on a retrieved processing rule or performance of a message processing action. IP states are discussed in more detail with respect to FIG. 10. Otherwise, a processing action should be performed. This step is discussed in more detail below.

If performance of a message processing action is not required at step 640, operation continues to step 660. If a message processing action is required, then operation continues from step 640 to step 650. At step 650, the MTA performs a message processing action. Operation then continues to step 660. The message processing action is discussed in more detail below. Electronic message information can be sent to message storage 250 at step 660. Once received by message store 250, electronic message information is stored until requested by a mail server.

In some embodiments, not all electronic messages are sent to message store 250. For example, electronic messages determined to be UBE at step 630 may not be sent because they are deleted. Additionally, messages received from bad unique sender may not be forwarded. In this case, method 600 ends at step 650. This is discussed in more detail below.

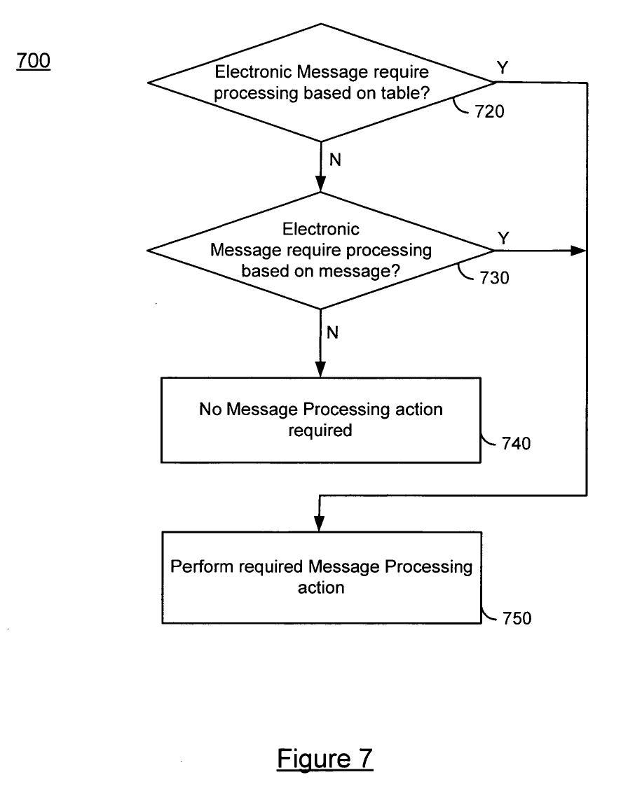

FIG. 7 illustrates one embodiment of a method 700 for determining if an electronic message requires performance of a processing action as discussed above in step 640. Each electronic message received at step 610 is associated with unique sender information. For purposes of discussion, the unique sender will be assumed to be source IP address information for purposes of method 600. The source IP address is either included in the message or retrieved from DNS 230.

At step 720, the system determines whether the received electronic message requires processing per the source IP address rule table. The table indicates whether or not processing is to be performed for messages received from specific source IP addresses. If the source IP address of the received message is found on the rule table, processing of the message is required as indicated in the table and operation continues from step 720 to step 750. If processing is not required according to the rule table, operation continues to step 730.

The MTA determines whether the message should be processed based on the message itself at step 730. At this step, although the table does not require the processing of electronic message, the message content may cause the MTA to perform some processing or throttle action on the message. For example, if the percentage of UBE messages received from the IP source by the receiving MTA is higher than a threshold value, then processing may be required. If no processing is required at step 730, operation continues to step 740. If processing is required at step 730, then operation continues to step 750.

As discussed above with respect to step 368, a message may be processed if the unique sender of the message has an IP that is similar to a known IP. In this case, at step 730 of method 700, a processing level may be set for the unrecognized unique sender IP that is similar to the recognized unique sender IP processing level.

The MTA has determined that no processing action is required at step 740. In one case, the IP source is recognized as a trusted or good source at step 720 and the electronic message does not change that state at step 730. In another case, the MTA may determine that messages from the message source are generally subject to processing, but this particular message is not. For example, a total of twenty messages may be allowed from a source within a period of time. In this case, no processing is required from messages received from the source until the twenty-first message is received.

At step 750, the message is identified as either coming from an unknown source, recognized within a source IP table or otherwise requiring processing. If the need for processing originated from the detection of the message source on a source IP list or source IP address rule table at step 720, several actions can be performed on the electronic message at step 650 of method 600. These actions can include responding with a transient error response, generating a delay in the response to the message, blocking the IP at the network level, blocking the message at the MTA level, instructing the network to divert future connections from this source to a set of mail servers having limited resources, limiting the number of recipients allowed for a message, limiting the number of total messages received from a source IP address and other actions. If an electronic message source IP address is not included in the processing table at step 720 but was identified for processing at step 730, the actions to be performed at step 650 of method 600 can include the same actions as discussed with respect to 720.

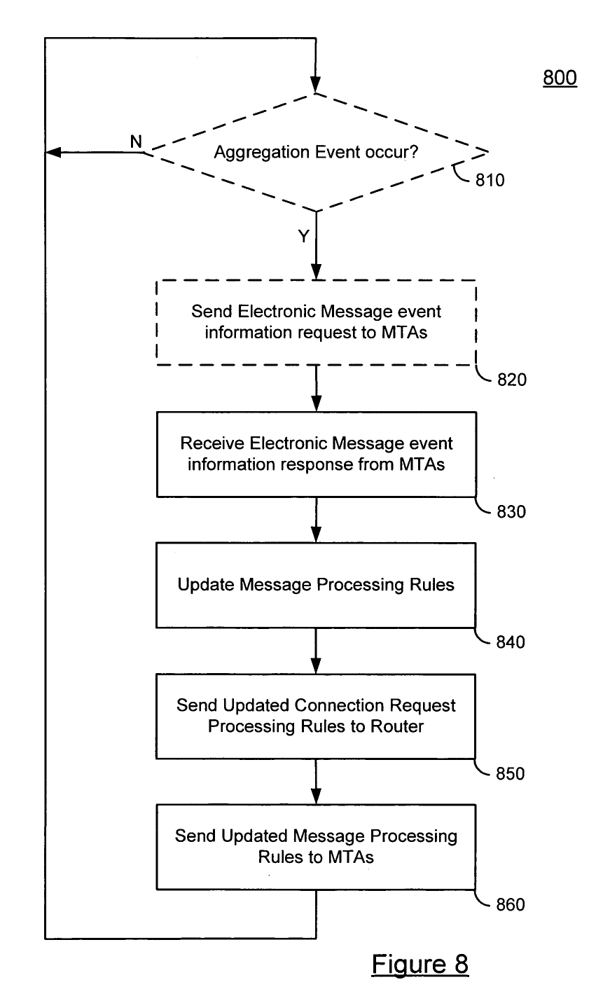

FIG. 8 illustrates a method 800 for processing message information by MIS 240. In general, MIS 240 operates to collect electronic message information from the MTAs, aggregate the information, generate message processing rules, and provide the message processing rules to router 210 and MTAs 220-226. MIS 240 determines if an aggregation event is occurs at step 810. In one embodiment, an aggregation event may be triggered be a request from MIS 240 to the MTA 220-226 for electronic message event information. In another embodiment, the MTAs deliver electronic message event information to MIS 240 at an MTA determined frequency, without a previous MIS request. In some embodiments, the aggregation event can be triggered or occurs when a signal is received by MIS 240 from an outside source, upon the expiration of a timer, a counter event or some other event. If no aggregation event is occurs at step 810, operation remains at step 810 until an event is triggered. If an aggregation event is triggered at step 810, operation continues to step 820.

Electronic message event information requests are sent to one or more MTAs at step 820. In some embodiments, steps 810 and 820 may be performed independently of the remainder the steps of method 800. In this case, steps 810-820 may be performed concurrently and independently as steps 830-860. In one embodiment, an electronic message event information request is sent to every MTA in an electronic message processing system such as that of FIG. 2. In another embodiment, the request is sent to a representative number of MTAs in a tiered aggregation system. In this case, the representative aggregators then forward the request to additional MTAs. In another embodiment, no request is sent and individual MTAs trigger the delivery of the electronic message event information either directly to the MIS or through a tiered system of aggregation servers that ultimately delivery the message event information to the MIS.

Next, MIS 240 receives electronic message event information responses at step 830. The responses can be direct or through a tiered system of aggregation servers. In some embodiments, the electronic message event information responses include message event information in the form of a log event, a table, binary data, or in some other format. In any embodiment, the information can be sub-sampled on the MTA and subsequently extrapolated by the MIS. In another embodiment, the electronic message event information may be compressed before transmission and expanded upon receipt. The compression may be performed by standard algorithms and formats (such as ZIP) or some other method. For example, every tenth log event of an MTA message log can be sent to MIS 240 in response to an electronic message event information request.

Next, MIS 240 updates the message processing rules at step 840. In one embodiment, this includes aggregating the electronic message event information received in the electronic message event information responses into a table. In some embodiments, the electronic message event information is aggregated into a table or some other format and stored on a data storage device such as a database. An example of such a table is illustrated by source IP address aggregation table 1000 of FIG. 10. Once the electronic message event information is aggregated into a table, MIS 240 determines the IP state and processing action for each electronic message source. This is discussed in more detail below.

In another embodiment, as part of updating a message processing rule, MIS 240 may perform a query to determine if a unique sender is an open proxy. In some embodiments, an MTA may make the determination as to whether a unique sender is an open proxy as well. An open proxy is an entity or service that accepts and processes connection requests to a third party on behalf of any requestor without restriction, such as the requestor being on certain network, requesting access to a certain network, or having provided pre-established authentication credentials. This allows originators of UBE to send messages to recipients without revealing the source of the emails. In one embodiment, a query may include contacting the unique sender source IP or source IP domain and requesting a connection to MTAs 220-226. If the source IP processes the connection attempt, it confirms that a message can be sent out on behalf of the requesting system, and then a processing rule is generated that requires blocking of future messages from the open proxy. In one embodiment, the processing rule may require that messages from the open proxy be blocked for a period of time, such as twenty-four hours. If a source IP is blocked three times, a harsher rule may be generated, such as blocking connection requests and electronic messages from the source IP permanently. If upon the first query the source IP is not determined to be an open proxy, the system may continue to test the source IP at some interval, such as about every seventy-two hours. In another embodiment, IPs may be blocked for seventy-two hours so that any open proxies which are turned off on weekends will test positive again on the first day of the week.

Next, the connection request processing rules are sent to router 210 at step 850. In one embodiment, the entire policy or just a portion of the policy that applies to router 210 is sent at step 850. For example, a portion that applies to router 210 may include a number of IP addresses for which connection requests should not be answered or directed to certain MTAs (possibly a subset of all MTAs). In this case, the rules associated with actions performed by MTAs are not sent to the router.

The processing rules are then sent to MTAs 220-226 at step 860. The rules sent to MTAs may be a the complete processing rules or just a portion of the rules relevant to the MTAs. For example, the portion of the rules relevant to the MTAs may include the remaining rules not applied to the router. In one embodiment, the portion of the rules applied at the MTAs may process email sources requiring more expensive or detailed processing or sample the behavior of sources previously blocked at the router. This is discussed in more detail below. Operation then continues to step 810 where MIS 240 awaits the next aggregation event.

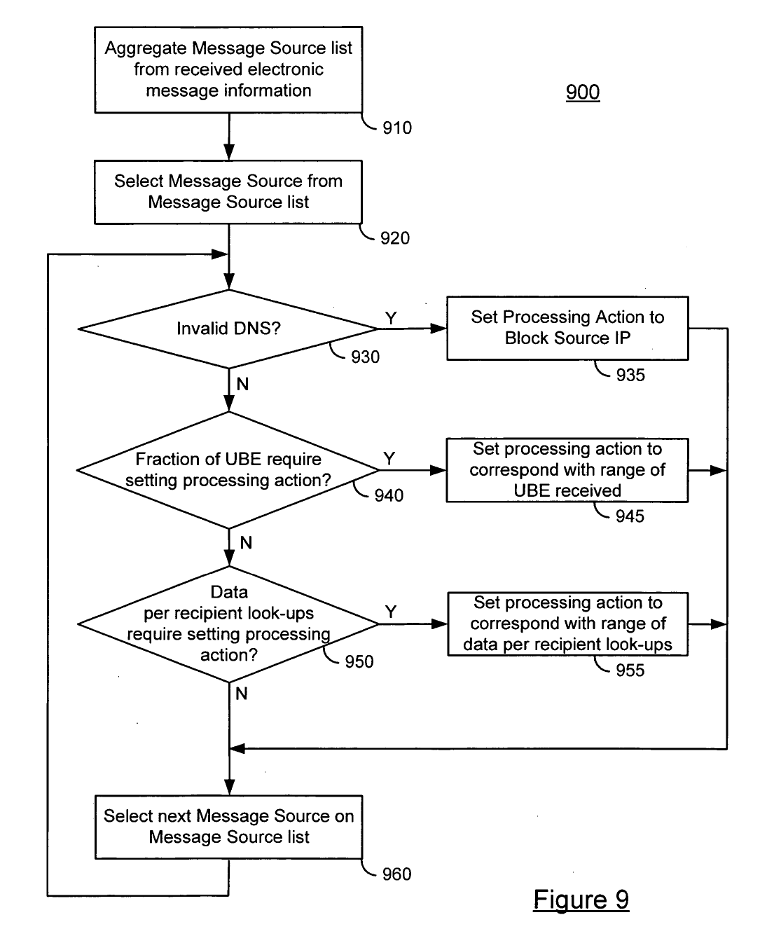

FIG. 9 illustrates one embodiment of a method 900 for updating message processing rules as discussed above in step 840. A message source list is aggregated from received electronic message information at step 910. The message source list may include a list of source IP addresses or domain names. In one embodiment, the aggregated data is maintained in a table. In this case, the information associated with a first electronic message is added as a row in a table such as aggregation table 1000 of FIG. 10. The information may include the message source as well as other information as discussed below with reference to aggregation table 1000. Next, information associated with a second electronic message is retrieved. MIS 240 then determines if the source of the second message is located in the table (ie, if the first and second message are from the same source). If so, the details of the second message (such as whether it is UBE, etc.) are added to the table in the same row as the existing source information entry. If not, a new row is added to the table and the information for the second message is added to the table in the new row. This is repeated for the remainder of the messages for which the MIS received information for.

Aggregation table 1000 is generated by MIS 240 from the electronic message information received from MTAs 220-226. Aggregation table 1000 of FIG. 10 includes column headings of message source IP, DN, total messages, UBE recipient messages, recipients per message, message state and message processing action. In one embodiment, other metrics of message events received from unique senders can be tracked for as well, including the number of recipient messages or total recipient messages. The message source IP column can include a list of IP source addresses associated with received electronic messages. In another embodiment, the domain of the message could be used, though this may not provide results as accurate as using a specific IP address, unless techniques are used to authenticate the use of domain names by the IP. The DN column indicates whether a source IP address is valid or not. In one embodiment, a source is determined to be valid by confirming the source IP address with DNS 230 as discussed above. Additional domain verification information can be tracked as well, such as SPF, sender identification information, information specific to an email service provider, such as DomainKeys information from Yahoo! Incorporated, of San Jose, Calif., or IIM information from Cisco Systems Incorporated, of San Jose, Calif.

The total messages column indicates the total number of messages received from each message source. The UBE messages column indicates the number of messages received from a source that have been determined to be Spam or UBE. The recipients per message column indicates an average number of recipients per message received from the message source. The source state indicates a current state for the message source and is derived from previous electronic messages. Examples of source states include trusted, good, bad, suspicious, probation and other states. The message processing action column indicates a current processing action that should be applied to messages received from the source IP. Aggregation table can include other columns as well, such as maximum recipients per message.

In one embodiment, information is aggregated at step 910 in columns of source IP, DNS, total messages, UBE messages and recipients per message. After the source IP address list has been aggregated at step 910, a source IP address is selected from the message source list by MIS 240 at step 920. In one embodiment, the first message source is selected at step 920. The IP state and IP processing action can now be determined for each source IP address. A processing action may consist of an action or rule that processes future electronic messages from a source IP address. The processing action is derived from the aggregated information as discussed below.

MIS 240 determines whether the source IP address is associated with an invalid domain name at step 930. In aggregation table 1000, a DN bit representing the validity of the domain name is set to one for an invalid domain name. The DN bit is set to zero to indicate the domain name is valid. If the domain name for the source IP is invalid at step 930, operation continues to step 935. At step 935, the MIS determines that the domain name is invalid (or missing) and the source IP should be blocked. In one embodiment, the IP state is set to bad and the IP processing action is set to “block”. In another embodiment, the IP state is set to bad and the IP processing action is set to limit the traffic received from source IP. Operation then continues to step 970.

In one embodiment, a block action can be implemented in a variety of ways. A block can be implemented by responding to an electronic message with a transient error, by dropping a connection made with the source or in some other manner. A transient error is well known in the art. In one embodiment, the connection can be dropped in response to receiving the domain name information of the sender during the SMTP connection process. The block can be implemented at the router or an MTA. In one embodiment, a processing action of blocking is maintained for a period of time. For example, a block may be maintained for twenty-four hours. After the block period has expired, a limited amount of connection requests and electronic messages may be accepted from the IP source. In one embodiment, if an IP source is blocked a number of times, for example three times, connection requests and electronic messages from the source may be blocked for a much longer period of time, such as three months or permanently.

At step 940, the system determines if the fraction of UBEs associated with the source IP requires a processing action. In one embodiment, a processing action should be set for a source IP address if the percentage of UBE received from the source reaches a threshold level. For example, if the total messages received from the source is 1000 messages and 500 of the messages are UBE, 50% of the messages received are UBE. This and other thresholds disclosed herein may be set by a system administrator or automatically by a system. A processing system or system administrator may determine that this is an unacceptable amount of UBE. If the number of UBE requires a message processing action, operation continues to step 945. If the number of UBE received does not require a processing action, operation continues to step 950.

At step 945, the processing action is set to correspond to a range of UBE received. For example, if the UBE comprises between 90% and 100% of the total messages received from the source, MIS 240 may set a processing action to block all messages from that source. If the percentage of UBE is 70%-90% of the total messages, MIS 240 may determine to limit the messages allowed from that source to 100 total messages over a period of time. If the percentage of UBE is 60%-70%, then MIS 240 may limit the number of messages received over a period of time to 500. If the percentage is less than 60%, MIS 240 may limit the total messages received to 1000. These ranges and corresponding actions are provided as examples only. In one embodiment, when the number of messages allowed from a message source is limited to a particular number, each MTA can be allowed to receive a fraction of that number. For example, if the number of allowed messages from a message source is 100 and a system includes 10 MTAs, each MTA may receive 10 messages. If the maximum allowed number of messages is 500, then each of the 10 MTAs can receive up to 50 messages from that source. In other embodiments, the quota allowed by each individual MTA may be calculated non-linearly, and may also be based on the latency of the various components of the system in their ability to react to sender behavior. After step 945, operation continues to step 970.

At step 950, MIS 240 determines if the average data per recipient look-up ratio for messages from a unique sender requires message processing. Senders of UBE often search perform queries for recipient names without sending data. In most cases, typical electronic messages senders have a data per recipient ratio of eighty to ninety percent. In one embodiment, the threshold value may require processing if it exceeds a threshold in the range of seventy to eighty percent. If the number of data per recipient look-up requires a message processing action, operation continues to step 955. If the data per recipient look-up per message does not require a processing action, operation continues to step 970.

The electronic message processing action is set to correspond to the range of recipients per message at step 955. For example, if the data per recipient look-up per message ratio is fifty percent, , MIS 240 may determine that the IP state is bad and likely sending UBE. In this case, the message processing action can be set to “block” messages received from that source. If the data per recipient look-up per message ratio is seventy percent, MIS 240 may place that source on probation and set the message processing action to limit the number of the data per recipient look-up per message ration to one. These ranges are discussed for purposes of example only. Other ranges, IP states and message processing actions can be used. Operation then continues from step 955 to step 970.

In some embodiments, other data and information may be used to configure rules in addition to those discussed above in method 900. For example, the data may include metadata such as historical, trap account, user complaint, third party status, open proxy/relay testing data, and other data. Historical data for a unique sender may be used to recognize a significant change in messages or message recipients from a unique sender. Thus, if 1,000 messages are received from a unique sender over a second, and historically the sender has averaged ten messages per minute for the last three days, a rule should be configured for processing future messages from the unique sender.

Trap accounts are email accounts maintained by an email service provider (ESP) but not associated with a user of an ESP. For example, the trap account may be maintained by an ESP system administrator. Trap accounts are operating accounts, but since they are not associated with any user they are not signed up for or otherwise linked to with any mailing lists, requests for electronic messages, or otherwise known to anyone outside the ESP. Thus, as trap accounts receive emails, the senders of the completely unsolicited emails can be automatically categorized as UBE sources and rules can be generated for the senders for all email system users as appropriate.

User complaint data can be used to configure rules for processing incoming messages. User complaint data can involve email system user feedback identifying UBE or other messages from unique senders that was or was not detected by an ESP. After receiving user feedback, future messages from the particular sender can be limited, blocked, or otherwise processed. Though configuring rules from user feedback has a higher latency associated with the time required for a user to view and provide feedback on a message, it allows for a very specific group of offending senders—those who have successful techniques for avoiding other types of detection—to be targeted.

Third party status is an external list of senders with an associated reputation connotation for the members of the list (such as, good or bad). Third party status can be a powerful positive or negative input in a message processing system. Symmetrically, third party lists of senders can serve to increase or decrease the system's tolerance for behavior, mailing patterns, message content or characteristics. Some lists are used proactively to prevent a sender from ever sending a message to the system or to guarantee its free passage through potential delivery obstacles. Others can be consulted in real time when suspicious behavior is detected to sway the processing actions towards more or less lenient treatment. The fundamental utility of third party information is connecting various parts of the internet so that a sender cannot abuse different parties in sequence, or conversely broadly communicate the positive behavior of a sender such that it does not need to establish credibility with each distinct place it sends mail to. Third party status list providers use vastly differing criteria for establishing membership on the list-from traffic patterns or complaint handling history, to financial status or open proxy detection.

Rules for processing electronic messages can be derived from open proxy and relay testing data. Open proxies allow originators of UBE to send electronic messages without disclosing the original source. In one embodiment, a list of candidates of possible open proxies can be generated based on event activity detected at an MTA. In particular, the list may include UBE sources that send out a large number of messages. Each open proxy candidate will be queried through various proxy ports to relay or forward an electronic message on behalf of another entity. If the open proxy performs the relay, a rule can then be configured that blocks subsequent electronic messages or connection requests from the open proxy.

Data used to configure rules may also include sender classification data. Examples of sender classification data that can be used include hostname heuristics, message forwarding entities, and hostname similarity data. Message forwarding heuristics can be used to configure rules for processing electronic messages. Some users may have alias email accounts in different domains, such as college alumni, professional organization and work email accounts. These different email accounts may be configured to forward emails to another address within the domain of an ESP of the present invention. As a result, different message forwarding systems can be treated differently. For example, a message source with a domain ending in .edu may be allowed a higher quota of incoming electronic messages than other message sources with the same incoming message event history. In some embodiments, other ways of identifying one or more message forwarders can be implemented, such as that described in U.S. patent application Ser. No. xx/xxx,xxx, entitled, “Identification of Email Forwarders”, filed on Dec. 27, 2004, having inventors Geoffrey Hulten et al., currently pending.

A history of known worm infection requests having been originated by the sender can also be used to inform a decision on a unique sender. The transmission of such a request indicates that the sender itself is likely infected, and thus that its messages are likely to be of an undesirable nature. The combination of such a history with, for example, heuristics indicating that the sending machine is an end-user machine makes this inference even likely.

Hostname similarity data may be used to configure electronic message processing rules. New message senders similar to other established or trusted message senders may be allowed a higher quota of incoming message events than other new message senders not related to currently trusted senders. For example, if alpha.source.com and beta.source.com are both trusted message sources, then new message source gamma.source.com may be given a higher level of trust than other new message sources not related to currently trusted message sources.

In some embodiments, rules may be configured by setting a quota for a message source. In this case, a quota is a number of incoming electronic messages, message requests, or other message events which one or more MTAs may be configured to receive for a sender of messages or other message events. In one embodiment, quota settings are used primarily for newer messages sources. A quota can be determined to limit the amount of messages from a sender to some number less than the acceptable messages or message events previously received from the sender. For example, a sender who has sent 1000 message requests the previous day may have a quota of 120% of their acceptable messages. In this case, a rule may be configured to allow up to 1200 messages from the particular sender over a time period up to one day.

In some embodiments, multiple types of data may be used simultaneously to determine what rules to apply to a source IP. As one example, the combination of high volume with high spam fraction may be criteria required to set an IP's state to bad and set the message processing action to block.

Message processing rules can change for a source IP address over time. In one embodiment, a source IP can receive an increased bandwidth of messages or recipients per message over time if previously set limits are not infringed. Additionally, a source IP can receive a reduced bandwidth of messages or recipients per message over time if previously set limits are infringed. In one embodiment, the bandwidth for a source IP address may be reduced more quickly if the source IP has an unfavorable IP state or history of IP states (e.g., is or previously had an IP state of “bad” or “probation”).

Returning to method 900, at step 970, MIS 240 has set the IP states and message processing action for sources of electronic messages or determined that no message processing action needs to be set. MIS 240 then selects the next source IP address from the source IP table such as that shown in FIG. 10 at step 970. Operation then continues to step 930.

Source IP aggregation table 1000 illustrated in FIG. 10 is now discussed in detail. In aggregation table 1000, a number of source IP addresses are listed with message information, IP states and message processing actions. For source IP address 10.2.3.10, the total number of messages received is 1000, the number of UBE messages is 300, the number of recipients per message is 4, the IP state is set to “trusted” and the message processing action is set to “small margin”. Because the source IP 10.2.3.10 has a low percentage of UBE messages (30%) and a relatively low number of recipients per message (4), the IP state is set to trusted. The message processing action is set to allow a “small margin” of messages above the average number of messages received from the source. For example, with an average of 1000 messages received during a time period, up to 1200 messages can be accepted during the next time period.

Source IP 10.2.3.11 has a DNS bit set to one. This indicates that the source IP BBB.com has an invalid source IP or no host name. Correspondingly, the IP states for 10.2.3.11 is set to “bad” and the message processing action is set to “block”. Source IP 10.2.3.12 has 1000 total messages and 900 UBE messages. This indicates 90% of the messages received from 10.2.3.12 are UBE. Correspondingly, the IP state for 10.2.3.12 is set to “bad” and the message processing action is set to “block”. Source IP 10.2.3.13 has an average of forty-five recipients per message. This indicates that messages from 10.2.3.13 are probably UBE. Accordingly, the IP state for 10.2.3.13 is set to “bad” and the message processing action set to “limit recipients”. In one embodiment, the message processing action can also include information regarding a number of recipients to allow for each message received from the source IP address 10.2.3.13 (not shown).

Source IP 10.2.3.14 has a number of UBE messages representing half the total messages received. A system may be configured to recognize this percentage of UBE as suspicious, but not amounting to a “bad” source. As a result, the IP state is set to “suspicious” for this source IP. The message processing action is set to “limit messages”. In one embodiment, the message processing action may also indicate the number of messages up to which will be accepted from the source IP 10.2.3.14. The source IP 10.2.3.15 includes an average value of recipients per message of 40. Again, a system may be configured to recognize this number of recipients as suspicious, but not amounting to a “bad” source. Thus, the IP state for 10.2.3.15 is set to “probation”. The message processing action is set to “limited messages”. In one embodiment, an individual MTA may be quick to apply stricter rules based on subsequent messages received from a source IP address having a “probation” IP state. Finally, the source IP 10.2.3.16 includes a number of UBE messages 600. The total number of messages received from 10.2.3.16 are 1000. In the embodiment shown, this can be a suspicious number of UBE messages. As a result, 10.2.3.16 has an IP state of “probation” and the IP processing policy is set to limit the number of messages from 10.2.3.16.

Table 1100 of FIG. 11 illustrates a source IP address rule table sent by MIS 240 at step 850 and 860 of method 800. In one embodiment, the information of rule table 1100 is derived from information in aggregation table 1000 of FIG. 10. In particular, rule table 1100 includes the first and last two columns of aggregation table 1000. Rule table 1100 includes column headings of source IP, IP state and the message processing action. MIS 240 can send this information to the MTAs and/or to router 210. In the embodiment shown, the message processing action includes additional information for some source IP addresses than those shown in FIG. 10. For example, the processing action for source IP 10.2.3.11 indicates that messages should be blocked by not accepting a connection. The message processing action for 10.2.3.12 indicates that messages should be blocked by sending a transient error in response to connection requests. The message processing action for 10.2.3.14 indicates that the messages should be limited by adding latency to the acceptance process and for 10.2.3.15 indicates the number of messages received should be limited to a maximum number of messages X. These processing actions are variations of those shown in aggregation table 1000. The variations can be determined by the MIS 240 before the rules are sent to router 210 and MTAs 220-226.

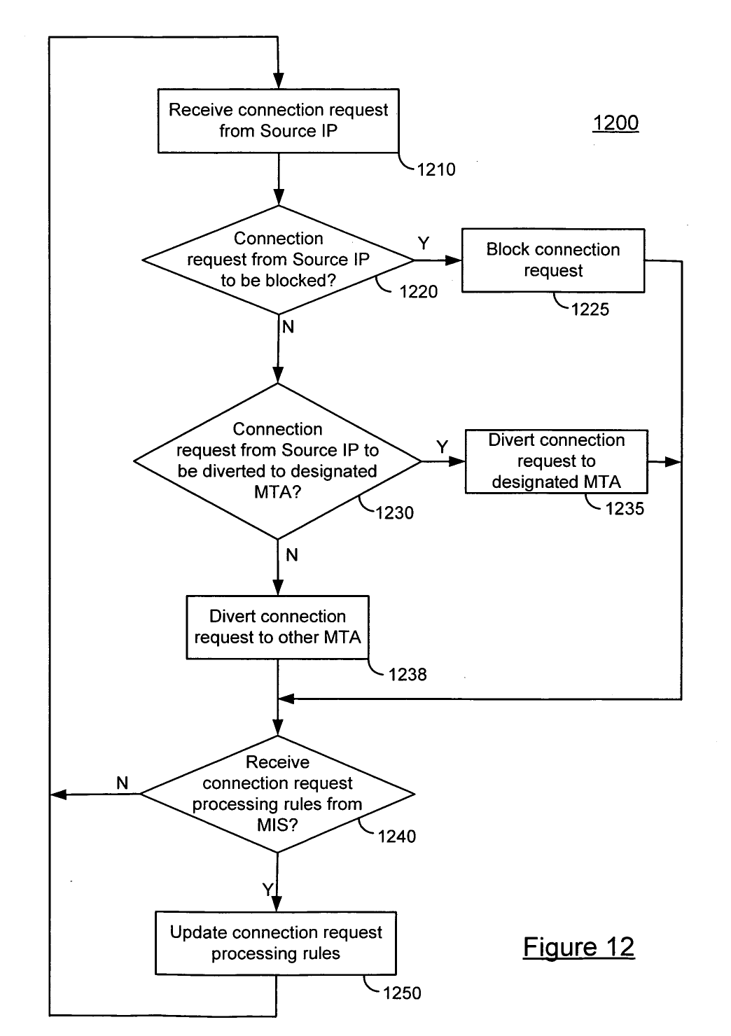

FIG. 12 illustrates one embodiment of a method 1200 for processing electronic messages by router 210 of FIG. 2. In one embodiment, method 1200 may be used to implement step 430 of FIG. 4. In one embodiment, an access control layer 215 within router 210 implements method 1200. A connection request is received by router 210 at step 1210. The connection request is received from an external source, such as a sending MTA of FIG. 1. Router 210 then determines whether the connection request should be blocked at step 1220. In one embodiment, a connection request can be blocked before the electronic message associated with the connection request is considered received (requested connection is received when it is accepted).

In one embodiment, in determining whether to block a connection request at step 1220, the router retrieves the source information from the received connection request and checks the source information against a source IP address rule table. The source IP address rule table is received from MIS 240 as discussed above. If router 210 determines the connection request should be blocked per the source IP address rule table, operation continues to step 1225. If the router determines the message should not be blocked, operation continues to step 1230.

Router 210 blocks the incoming connection attempting to deliver the connection request at step 1225. The connection can be blocked in a variety of ways. In one embodiment, router 210 may simply drop the connection request packet from the source of the connection request. Router 210 may also refuse to forward connection acceptance packets (SYN/ACK) back to the source IP of the connection request. After the message is blocked at step 1225, operation continues to step 1240.

In one embodiment, router 210 can route connection request to one or more designated weak MTAs (for example, designated and containing limited bandwidth to process connection requests and electronic messages) or one or more strong MTAs depending on the source state of the source of the message. The strength of the MTA routed to can be dictated by the number of MTAs pooled together to handle good or suspicious sources. In another embodiment, the strength of the MTAs could be controlled by the speed of the hardware. In another embodiment, the strength of the MTAs may be controlled by global artificial software throttling, using techniques such as those described herein. In yet another embodiment, the strength of the MTAs may be defined in terms of how heavily loaded they are, or the fraction of their resources normally consumed by the demand for processing messages. A connection request may be routed to a strong MTA pool if it is from a source associated with a source state of “good”. A connection request may be routed to a designated weaker MTA pool if it is from a source associated with a source state of “bad”, “suspicious”, “probation”, “unknown”, or some other undesirable state. For example, MTAs 220-221 may be designated to process connection requests from a source having an IP state of bad, on-probation or suspicious. In some embodiments, the MTA processing connection request received from sources with these states will have a limited bandwidth to limit the number of connection requests they can process. MTAs 222-223 can be designated to process connection requests associated with the source having an IP state of trusted. In some embodiments, MTAs processing connection requests from these sources may have an unlimited or higher bandwidth.

Router 210 determines whether the connection request should be diverted to a weak MTA at step 1230. In one embodiment, determining whether to divert a connection request to a weak MTA requires checking the source information and source state of the connection request against the connection request source rule table. If the connection request should be routed to a weak MTA, operation continues to step 1235. Otherwise, operation continues to step 1238.

At step 1235, the connection request is diverted to a weak MTA or group of MTAs. Operation then continues to step 1240. At step 1238, the connection request is diverted to a strong MTA or group of MTAs. Operation then continues to step 1240. At step 1240, router 210 determines whether connection request processing rules have been received. In one embodiment, the connection request processing rules are received from MIS 240. If no connection request processing rules have been received, operation continues from step 1240 to step 1210. If connection request processing rules have been received, the processing rules are then updated and/or stored to memory of router 210 at step 1250. Operation then continues to step 1210.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for processing incoming message events, comprising:
determining a unique sender of a received incoming event;
setting a default level of event processing associated with the unique sender; and
selectively processing the incoming events from the unique sender based on the default level of event processing.

2. The method of claim 1, wherein said step of selectively processing includes:
determining an adjusted level of event processing based on the whether the incoming events are approved or unwanted; and
selectively processing the incoming events from the unique sender based on the adjusted level of event processing.

3. The method of claim 2, wherein said step of selectively processing the incoming events from the unique sender based on the adjusted level of event processing includes:
limiting the number of recipients per message data for the unique sender.

4. The method of claim 2, wherein said step of selectively processing the incoming events includes:
routing incoming events from the unique sender to one or more mail transfer agents with inadequate processing power to process all expected subsequent incoming events from the unique sender.

5. The method of claim 1, wherein said step of determining an adjusted level of event processing includes:
sampling a plurality of received incoming events to generate a set of sampled events; and
transmitting the set of sampled events using a connectionless datagram service.

6. The method of claim 1, wherein said step of setting a default level of event processing includes:
receiving a plurality of incoming events;
sampling the plurality incoming events from an incoming event log at a sampling rate for a period of time;
estimating the fraction of unwanted incoming events received from the unique sender over the period of time; and
determining the default level of event processing to correspond to the fraction of unwanted incoming events.

7. The method of claim 1, wherein said step of determining an adjusted level of event processing includes:
processing a type of data from the data set consisting of user complaint data, third party status data, open proxy data, relay testing data, sender classification data, and infection request data.

8. The method of claim 1, wherein said step of determining an adjusted level of event processing includes:
transmitting incoming event information using a connectionless datagram service; and
receiving event processing information, the adjusted level of event processing derived in part from the incoming event information.

9. The method of claim 1, wherein said step of determining an adjusted level of event processing includes:
determining that the unique sender is associated with a prior unique sender having a designated level of event processing; and
determining the level of event processing associated with the unique sender to be similar to the designated level of event processing associated with the prior unique sender.

10. The method of claim 1, wherein said step of setting a default level of event processing includes:
determining that the unique sender operates as an open relay or open proxy; and
determining that subsequent incoming events from the unique sender should be blocked for a period of time until it is determined that the unique sender no longer operates as a open relay or open proxy.

11. A method for processing incoming message events, comprising:
receiving a message event from a recognized unique sender;
retrieving a processing rule associated with the recognized unique sender; and
limiting the processing of subsequent message events received from the recognized unique sender based on the retrieved processing rule.

12. The method of claim 11, wherein the received message event is an acceptable message event, wherein processing of subsequent message events includes:
processing a limited number of subsequent message events that is higher than a previous limited number of message events associated with the unique sender.

13. The method of claim 11, wherein processing a limited number of subsequent message events includes:
determining that the message event from the unique sender is UBE and associated with message identification information; and
deleting subsequent message associated with message identification information.

14. The method of claim 11, wherein limiting the processing of subsequent message events includes:
limiting the number of recipients per data for the unique sender.

15. The method of claim 11, wherein processing a limited number of subsequent message events includes:
blocking a portion of subsequent connection requests at a router, the blocked portion being larger than a majority of the subsequent connection requests; and
forwarding the remainder of the connection requests to one or more mail transfer agents.

16. The method of claim 11, wherein limiting the processing of subsequent message events includes:
blocking all subsequent message events for a limited period; and
accepting a limited number of message events from the unique sender after the limited period.

17. A system for processing electronic events, comprising:
a plurality of message transfer agents, each of the plurality of message transfer agents able to generate message event information from message events received from one or more unique senders and accept a limited number of message events associated with a processing level for each unique sender; and
an aggregation server able to receive message event information from each of said plurality of message transfer agents and provide the unique sender processing levels to the plurality of message transfer agents.

18. The system of claim 17, wherein said aggregation server derives the unique sender processing levels from aggregated message event information.

19. The system of claim 17, wherein said plurality of message transfer agents includes a set of limited bandwidth message transfer agents configured to process incoming events associated with unique senders associated with unwanted received message events.

20. The system of claim 17, wherein each of the plurality of message transfer agents is configured to apply a default processing level to unrecognized unique senders, the default processing level allowing each message transfer agent to accept a limited number of message events from the unrecognized unique sender.
